(19) United States
(12) Patent Application Publication
(10) Pub. No.: US 2026/0038462 A1
(43) Pub. Date: Feb. 5, 2026

(54) DISPLAY CONTROL APPARATUS, METHOD EXECUTED BY DISPLAY CONTROL APPARATUS, AND STORAGE MEDIUM

(71) Applicant: CANON KABUSHIKI KAISHA, Tokyo (JP)

(72) Inventors: HAJIME KAJITA, Kanagawa (JP); TAKUYA KOSUGE, Kanagawa (JP)

(21) Appl. No.: 19/259,253

(22) Filed: Jul. 3, 2025

(30) Foreign Application Priority Data
Jul. 30, 2024 (JP) 2024-122942
Feb. 12, 2025 (JP) 2025-020828

(51) Int. Cl. G09G 5/373; G06F 3/04886; G06F 3/147; G09G 5/38; H04N 7/18

(52) U.S. Cl. CPC G09G 5/373; G06F 3/04886; G06F 3/147; G09G 5/38; H04N 7/181; G09G 2340/045; G09G 2340/0464; G09G 2354/00

(57) ABSTRACT

A display control apparatus is configured to acquire at least a first image among one or more images acquired by one or more image capturing apparatuses, and determine a cut-out region from the first image including a second angle of view region, based on at least one of a size of a display region of a thumbnail image on a display screen and a size of the second angle of view region that is smaller than a first angle of view region that is a region of an angle of view of the first image. The display control apparatus performs display processing to display an image which is cut out from the first image and which corresponds to the determined cut-out region.

### BACKGROUND

### Field

The present disclosure relates to a technology for controlling display of images captured by an image capturing apparatus.

### Description of the Related Art

In recent years, network cameras capable of controlling an image capturing apparatus remotely have become widespread. According to this approach, a user can perform settings related to image capturing, such as image capturing direction and the like, with respect to the image capturing apparatus and a pan-tilt head remotely by operating a controller for control and the like via a network.

Among network cameras, there are network cameras provided with a preset function that enables a user to register settings of the angle of view, such as pan, tilt, and zoom of the camera in advance. The network camera can change the angle of view by executing the registered preset without the user performing PTZ (pan, tilt, and zoom) operation manually. In a case in which the camera is provided with a function to generate thumbnail images from video at the time of registration of the preset, the user can visually confirm what kind of angle of view is obtained by execution of the preset from the generated thumbnail images. In addition, by causing thumbnail images obtained through such presets to be displayed in a list on a display apparatus, the user can confirm the angles of view of a plurality of presets side by side.

In contrast, among network cameras, there are network cameras provided with a crop function that can output video cropped from a part of a frame instead of the entire captured video (entire frame). The position and size of a region to be cropped can be controlled by a user during image capturing similar to PTZ operation. For example, as a network camera provided with a crop function, there are network cameras provided with a plurality of output systems. Such a camera, in a case in which a plurality of crop regions are set, can, for example, output a crop region 1 by an output system 1 and simultaneously output a crop region 2 by an output system 2.

In a camera provided with a crop function, in a case in which thumbnail images created from an entire image are registered, when a preset is executed in a state in which the crop function is turned on (a state in which a crop region is set), an image of the entire frame is not obtained as output video. In this case, the camera outputs an image cropped by the set crop region as one screen instead of outputting an image of the entire frame.

Here, for a user to confirm composition after execution of the preset from the thumbnail image in a state in which the crop function is turned on, for example, a method of displaying a frame in a crop region of the thumbnail image is conceivable. In Japanese Patent Application Laid-Open No. 2019-57891, a technology is disclosed wherein a small thumbnail image of an entire fisheye image is superimposed on a thumbnail image showing a part of a region of the fisheye image, and further, a frame line indicating a boundary position of a region in which a part of the above-described fisheye image is cut out is drawn within the thumbnail image of the entire fisheye image.

### SUMMARY

Thumbnail images of presets are often reduced in size when displayed. For example, in the method described in Japanese Patent Application Laid-Open No. 2019-57891, a cut-out region becomes too small, and visibility decreases.

The present disclosure provides a technology of display control for improving visibility of thumbnail images.

A display control apparatus according to one aspect of the present disclosure is configured to acquire at least a first image among one or more images acquired by one or more image capturing apparatuses, determine a cut-out region from the first image including a second angle of view region, based on at least one of a size of a display region of a thumbnail image on a display screen and a size of the second angle of view region that is smaller than a first angle of view region that is a region of an angle of view of the first image, and perform display processing to display an image which is cut out from the first image and which corresponds to the determined cut-out region as the thumbnail image on the display screen.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing a configuration example of a control system according to an embodiment.

FIG. 2 is a block diagram showing an internal configuration example of a controller according to an embodiment.

FIG. 3A to FIG. 3C are diagrams each showing an example of a display pattern of a list of preset thumbnails.

FIG. 4 is a flowchart showing thumbnail display processing in a first embodiment.

FIG. 5 is a diagram showing a calculation method of a cut-out region in the first embodiment.

FIG. 6A to FIG. 6C are diagrams each showing an example of a display pattern of a preset thumbnail list in the first embodiment.

FIG. 7 is a flowchart showing thumbnail display processing in a second embodiment.

FIG. 8A to FIG. 8C are diagrams each showing an example of a display pattern of a preset thumbnail list in the Second Embodiment.

FIG. 9A to FIG. 9I are diagrams each showing an example of a display pattern of a preset thumbnail list in a third embodiment.

FIG. 10 is a diagram showing a calculation method of a cut-out region of a thumbnail in a fourth embodiment.

FIG. 11A and FIG. 11B are diagrams showing differences in display forms with and without cut-out of a thumbnail in a fifth embodiment.

FIG. 12 is a flowchart showing thumbnail display processing in a sixth embodiment.

FIG. 13 is a diagram showing a calculation method of a cut-out region in the sixth embodiment.

FIG. 14A to FIG. 14C are diagrams each showing an example of a display pattern of a preset thumbnail list in the sixth embodiment.

FIG. 15 is a diagram showing a configuration example of a control system according to a seventh embodiment.

FIG. 16 is a flowchart showing thumbnail display processing in the Seventh Embodiment.

FIG. 17 is a flowchart showing thumbnail display processing in an eleventh embodiment.

FIG. 18 is a diagram showing an example of a display pattern of a preset thumbnail list in the eleventh embodiment.

### DESCRIPTION OF THE EMBODIMENTS

Hereinafter, with reference to the drawings, an explanation is provided with respect to embodiments of the present disclosure. It is not necessarily the case that all of a plurality of features in the embodiments of the present disclosure are essential, and a plurality of features may be combined arbitrarily. In addition, the configuration shown in the embodiments below is merely an example, and the present disclosure is not limited to the configuration illustrated. In the drawings, by assigning the same reference sign to the same or similar configurations, redundant explanation is omitted.

### First Embodiment

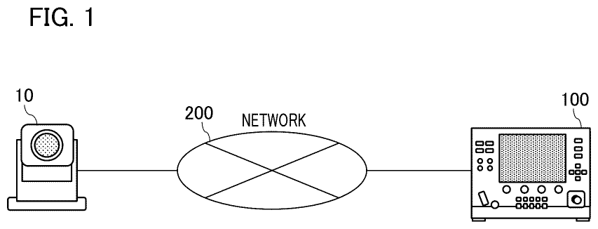

FIG. 1 is a diagram showing a configuration example of a control system in the present embodiment. The control system in the present embodiment is provided with a controller 100 and a camera 10. The controller 100 and the camera 10 are connected via a network 200. The camera 10 is an example of an image capturing apparatus. The controller 100 is an example of a display control apparatus that controls display of captured images acquired by the image capturing apparatus.

The control system is not limited to such a form. For example, the controller 100 and the camera 10 may be connected by SDI (Serial Digital Interface) or HDMI

(High-Definition Multimedia Interface). Although in the present embodiment one camera 10 is connected, the number and type of cameras are not particularly limited.

The camera 10 has one or more video-output interfaces and, at an angle of view controlled by the user via the controller 100, can output captured images to an external device (not shown) via the video-output interface. The above-described video output interface may be a video output interface connected to the network 200.

The controller 100 performs control with respect to the camera 10 based on a communication protocol for camera control and can acquire information of the camera 10. The controller 100 is, typically, a dedicated controller corresponding to one or more specific camera models including the camera 10. However, the controller 100 is not limited thereto and may be, for example, a PC, a smartphone, or a tablet computer, and the like.

The network 200 is configured by any one of, or a combination of two or more of, for example, a LAN, a WAN, a telephone line, a dedicated digital line, an ATM, a frame relay line, a cable television line, a wireless line for data broadcasting, and the like. As the LAN, for example, Ethernet can be utilized. As the WAN, the Internet can be utilized.

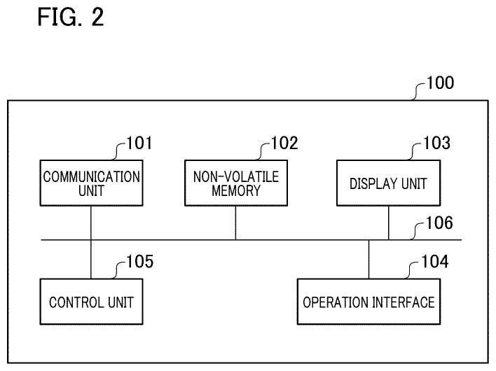

FIG. 2 is a block diagram showing an internal configuration example of the controller 100 according to the present embodiment. The controller 100 is provided with a communication unit 101, a non-volatile memory 102, a display unit 103, an operation interface 104, a control unit 105, and an internal bus 106 that enables mutual communication among these blocks.

The communication unit 101 is a network interface that performs communication with external devices (in this context, the camera 10) via the network 200. In this context, communication includes transmission of control commands to the camera 10 and reception of signals from the camera 10, and also reception of captured images. The controller 100, based on instructions from the control unit 105, in a case in which the controller 100 performs communication with the camera 10, performs communication via the communication unit 101.

The non-volatile memory 102 is a storage apparatus having non-volatility represented by flash memory, HDD, SSD, SD card, and the like. The non-volatile memory 102, in addition to being used as a persistent storage area that stores programs for the control unit 105 to control the controller 100, such as an OS, various programs, and various data, and the like, is also used as a storage area of various short-term data. In the present embodiment, although the non-volatile memory 102 is configured by an SSD, the non-volatile memory 102 is not limited thereto.

The display unit 103 is configured by a liquid crystal panel and a backlight, for example, and displays captured images and setting screens acquired from the camera. In the present embodiment, the display unit 103 displays images captured by the camera 10 and settings of the camera 10. That is, the display unit 103 provides a display screen, and in particular, displays thumbnail images as described below. It should be noted that although an example in which the controller 100 includes the display unit 103 is shown in the present embodiment, the controller 100 and a display apparatus (external monitor) may be configured as separate bodies. In this case, the controller 100 is provided with an interface that outputs video acquired by the camera 10 to an external monitor.

The operation interface 104 is an interface for receiving operations from users with respect to the controller 100. The operation interface 104 comprises operation members such as a plurality of physical buttons and joysticks provided on the housing of the controller 100, and/or a GUI (Graphical User Interface) displayed on the display unit 103. The GUI displayed on the display unit 103 may be a touch panel capable of touch operation by a user. The user inputs operation information to the control unit 105 by operating the operation members and/or the GUI. In this manner, settings of the controller 100 itself and control of cameras connected to the controller 100 can be performed. A detailed explanation thereof is described below.

The control unit 105 outputs an IP address of a target for which control is performed and a packet to be transmitted to the IP address to the communication unit 101. This packet includes types of target functions such as pan or tilt, and a command indicating what kind of control is performed with respect to the function. When the camera 10 receives this command, the camera 10 performs predetermined operations on the camera 10 side. When the communication unit 101 receives a response packet transmitted from the camera 10, the communication unit 101 outputs the information to the control unit 105, and based on the information, the control unit 105 performs acquisition of the state of the camera 10 and judgment of success or failure of communication.

The control unit 105 is provided with a processor (not shown) and a volatile memory. The processor of the control unit 105 expands programs stored in the non-volatile memory 102 into the volatile memory, and controls each block of the controller 100 by executing the expanded programs. The volatile memory (not shown) is a storage apparatus such as DRAM, and temporarily stores computer programs executed by the processor of the control unit 105. An OS, various programs, and various data are loaded into the volatile memory, and the volatile memory provides a work area for the control unit 105 to execute the OS and various programs.

The control unit 105 displays a menu screen (not shown) on the display unit 103. When the control unit 105 receives operations according to this menu screen from a user via the operation interface 104, the control unit 105 performs settings of the controller 100 and control with respect to the camera 10. For example, in a case in which the control unit 105 displays a list of preset thumbnail images on a screen, the control unit 105 performs processing of transmitting an acquisition instruction of preset thumbnail images to the camera 10.

A preset thumbnail image is a thumbnail image generated from video captured at an angle of view corresponding to pan, tilt, and zoom preset by the preset function. The preset function is, as described above, a function for a user to register settings of angles of view such as pan, tilt, and zoom of the camera 10 in advance. In the following explanation, “thumbnail image” and “preset thumbnail image” may be referred to simply as “thumbnail” and “preset thumbnail” in some cases. Execution of a preset is, after registration of the preset, by operation input of a user to the controller 100, the camera 10 executing image capturing at the angle of view of the registered PTZ.

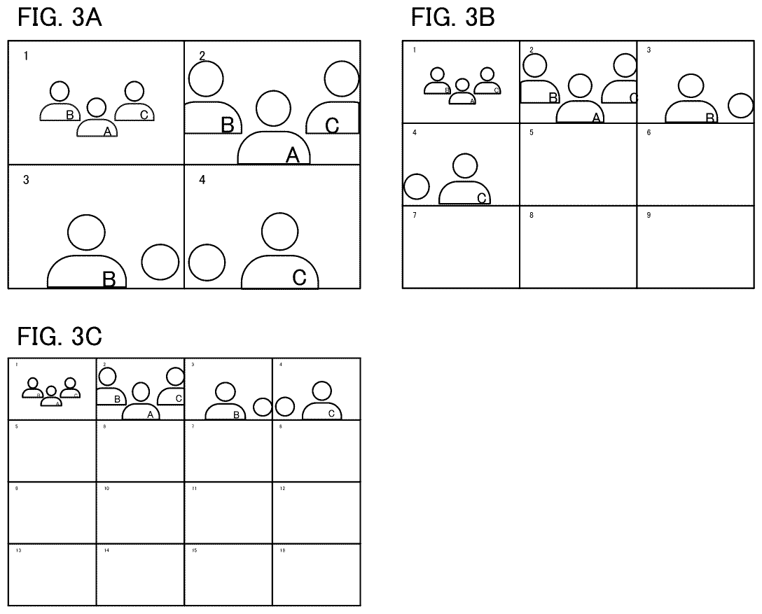

The displayed preset thumbnail list includes not only the entire thumbnail (image “1” of the below-described FIG. 3A) generated at the angle of view at the time of registration of the preset, but also thumbnail images that are cut out from, and enlarged relative to, the entire thumbnail. Each enlarged thumbnail is shown, for example, “2” to “4” of FIG. 3A. Hereinafter, an explanation is provided with respect to display examples of the preset thumbnail list.

FIG. 3A to FIG. 3C are diagrams each showing an example of a display pattern of a preset thumbnail list when a crop function is not used. An explanation with respect to the crop function will be provided in detail later.

In the examples shown in FIG. 3A to FIG. 3C, the number of thumbnails (display number) is four. The display number of thumbnails corresponds to the number of presets registered by a user. When one preset is registered, the control unit 105 displays one thumbnail on the display unit 103 by generating the one thumbnail from video captured at an angle of view corresponding to the registered preset.

As a display pattern of preset thumbnails registered in the camera 10, there are several matrix formats. For example, preset thumbnails are displayed in a “2×2” matrix in FIG. 3A, a “3×3” matrix in FIG. 3B, and a “4×4” matrix in FIG. 3C. Each thumbnail is displayed by being scaled according to the display pattern. For example, as the number of rows and columns increases, the size of the thumbnail is displayed smaller. Any one display pattern can be selected by operation of a user. In any display pattern, the user can confirm composition after execution of a preset from the displayed preset thumbnails. It should be noted that the user can execute a preset corresponding to a thumbnail by specifying an arbitrary thumbnail through selection of that arbitrary thumbnail from the displayed preset thumbnail list.

The display pattern of preset thumbnails is not limited to the matrix format, and may be a format arranged in the vertical direction (a format of only one column). In the format arranged in the vertical direction also, as the number of thumbnails increases, the size of the thumbnail may be displayed at a reduced size. It should be noted that the controller 100 may have a program for specifying and changing the display pattern in accordance with a user setting. Alternatively, the controller 100 may determine the display pattern according to the number of presets.

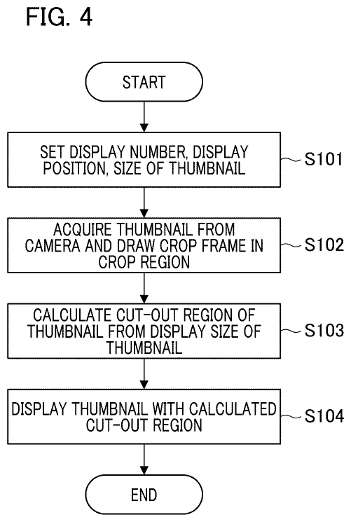

FIG. 4 is a flowchart showing an example of processing for displaying preset thumbnails that include a crop region. This processing is realized by the processor of the control unit 105 reading out a program corresponding to processing content stored in the non-volatile memory 102, loading the program into the volatile memory, and executing the program. Hereinafter, an explanation is provided with respect to preset thumbnail display processing in the control unit 105 and the display unit 103 by using the flowchart of FIG. 4. In the explanation of thumbnail display processing shown in FIG. 4 and the figures that follow, an example is explained in which the crop function is used and a crop frame is displayed by being superimposed on the generated thumbnail.

The crop function is, as described above, a function in which the camera 10 outputs video cropped (cut out) from a part of a frame instead of the entire captured video (entire frame) by operation input of a user to the controller 100. The user, by using the crop function, can crop a part of the frame at an arbitrary position, size, and shape within the frame. The shape of the crop region is typically rectangular. In a case in which the crop region is rectangular, although the aspect ratio of the crop region is basically a fixed value, the aspect ratio may be a configuration that can be set by the user.

In step S101, the control unit 105 sets the number of thumbnails (display number), position (display position), and size (display size, size of the display region) of thumbnails. The display number, display position, and display size are values determined for each of the above-described display patterns (for example, FIG. 3A to FIG. 3C). Here, for example, in a case in which the resolution of the display unit 103 is 1920×1080, the display size of the thumbnail is set as follows. If displaying in the “2×2” pattern, for example, the display size of the thumbnail is set to “large” (for example, 960×540), similarly, “medium” (for example, 640×360) for “3×3”, and “small” (for example, 480×270) for “4×4”.

In step S102, the control unit 105 acquires a preset thumbnail and information of position and size of the crop region from the camera 10. Then, the control unit 105 draws a frame in the crop region of the thumbnail based on the acquired information. This frame is a frame surrounding the crop region, and is an example of information indicating the crop region. Hereinafter, this frame is referred to as a “crop frame”. For example, in a case in which the crop frame is rectangular, the crop frame is represented as (x, y, w, h) by using coordinates (x, y) of the corner at the upper left of the frame, and width and height (w, h) of the frame.

The control unit 105 mainly serves as an example of an acquisition unit configured to acquire at least a first image among one or more images acquired by one or more image capturing apparatuses, in cooperation with a predetermined program.

Here, assume that the resolution of video acquired by the camera 10 is 1920×1080 and the crop region is (0, 0, 960, 540). In this case, if the display size of the thumbnail set in step S101 is 1280×720, a region of (0, 0, 640, 360) in the thumbnail can be drawn as the crop frame. It should be noted that the crop frame may alternatively be drawn by the camera 10 onto the thumbnail in advance when the thumbnail is generated from the video. The crop frame may be a solid line or a dashed line. Alternatively, the information indicating the crop region may be an image having a semitransparent color (for example, a rectangular image of semitransparent color, and the like).

In step S103, the control unit 105 calculates a cut-out region of the thumbnail based on the display size that was set in step S101. In the present embodiment, calculation of the cut-out region mainly means calculation of a magnification factor (magnification factor of the thumbnail image) of the cut-out region. As described below, it is necessary to note that the cut-out region and the crop region differ in meaning.

As the display size of the thumbnail becomes smaller, the thumbnail becomes more difficult to see for the user. Accordingly, in order to display an appropriately sized thumbnail according to the display size of the thumbnail list, the control unit 105 executes processing of performing an appropriate size cut-out from a frame acquired from video at the time of registration of the preset, and enlarging the cut-out region. Here, in a case in which a crop region is set, the control unit 105 generates a thumbnail by cutting out a region including the crop region. Hereinafter, an explanation is provided with respect to the process of generating a thumbnail by cutting out a region including the crop region.

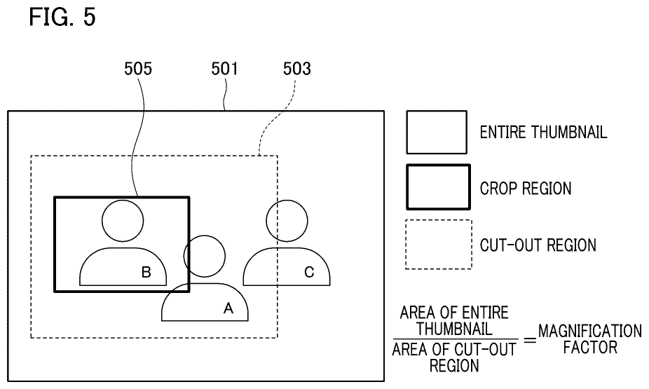

FIG. 5 is an explanatory diagram showing a calculation method of a cut-out region 503 of a thumbnail. In FIG. 5, with respect to a thumbnail (entire thumbnail 501), a crop region 505 is represented by a thick frame, and the cut-out region 503 is represented by a dashed line. The cut-out region 503 is a region that is displayed on the display unit 103 as a new thumbnail, and regions other than the cut-out region 503 are not displayed. A magnification factor can be obtained by (area of the entire thumbnail 501)/(area of the cut-out region 503). In the present embodiment, as the display size of the thumbnail becomes smaller, the size of the cut-out region becomes smaller, that is, the magnification factor of the cut-out region is set so as to become larger. For example, in a case in which the display size of the thumbnail is “large” (960×540), the magnification factor is set to 100%, in a case in which the display size of the thumbnail is “medium” (640×360), the magnification factor is set to 200%, and in a case in which the display size of the thumbnail is “small” (480×270), the magnification factor is set to 500%.

The position (position of the thumbnail) of the cut-out region 503 and an upper limit of the magnification factor are set so that the crop region 505 is included in the cut-out region 503. For example, the cut-out region is determined so that the center of the crop region is positioned at a position as close as possible to the center of the cut-out region. Alternatively, the cut-out region is determined so that the crop region is positioned at a position according to a predetermined algorithm other than the above-described center positioning method.

In step S103, the control unit 105 mainly serves as an example of a determination unit configured to determine a cut-out region from the first image, in cooperation with a predetermined program. The preset thumbnail is an example of a first image. The angle of view region of the preset thumbnail is an example of a first angle of view region. The crop region is an example of a second angle of view region. It should be noted that in the Sixth Embodiment and thereafter, the preset thumbnail is an example of a second image.

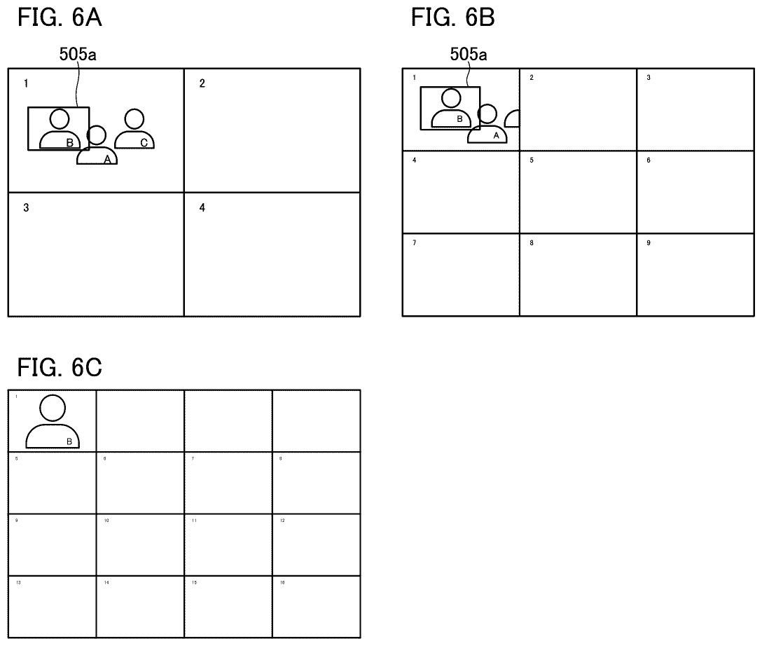

In step S104, the control unit 105 displays the cut-out region enlarged with the magnification factor calculated in step S103 as a thumbnail on the display unit 103. At this time, the control unit 105 displays a crop frame 505a also superimposed on the thumbnail. FIG. 6A to FIG. 6C are diagrams each showing a display example of a thumbnail including the crop frame 505a.

In FIG. 6A, the display size of the thumbnail is “large”, and the magnification factor of the cut-out region is 100%, that is, substantially the entire image of the original thumbnail is displayed as the thumbnail without any change.

In FIG. 6B, the display size of the thumbnail is “medium”, and the magnification factor of the cut-out region is set to, for example, 200%.

In FIG. 6C, the display size of the thumbnail is “small”, and the magnification factor of the cut-out region is set to, for example, 500%. In FIG. 6C, for example, only the crop region is cut out and displayed as the thumbnail. Here, an example is shown in which the cut-out region and the crop region are identical. In a case in which the cut-out region and the crop region 505 are identical in this manner, the crop frame may not be displayed. Alternatively, the crop frame may be displayed along the outline of the entire cut-out region.

An upper limit may be set for the magnification factor (a lower limit of the size of the cut-out region). For example, in a case in which the crop region is excessively small, if the magnification factor is determined so that the cut-out region becomes the same as the crop region, the resolution of the displayed thumbnail becomes excessively small and becomes difficult to see. To prevent this, the upper limit of the magnification factor may be set in advance.

In contrast, the lower limit of the magnification factor may be set to a value greater than 100%, and even in a case in which the display size of the thumbnail set by the user is “large”, the thumbnail may be displayed by being enlarged.

In step S104, the control unit 105 mainly serves as an example of a display processing unit that performs processing of displaying an image cut out from the first image within the determined cut-out region as the thumbnail image on the display screen, in cooperation with a predetermined program.

As described above, according to the present embodiment, the controller 100 acquires a preset thumbnail and a crop region from the camera 10 having a crop function, and sets the magnification factor of the cut-out region to be larger as the display size of the thumbnail becomes smaller. In this manner, in a case in which the display size of the thumbnail is “large” or “medium”, the user can see not only the crop region but also outside the crop region in the preset thumbnail, and the composition after cropping becomes easier to see. In contrast, in a case in which the thumbnail is relatively small, for example, smaller than “medium”, the user can confirm the crop region displayed by being enlarged. That is, visibility can be improved when the user confirms the thumbnail image including the crop region.

In the present embodiment, although the display size of the thumbnail is set in three stages of “large”, “medium”, and “small”, the display size of the thumbnail may be in two stages or may be in four or more stages.

### Second Embodiment

In a Second Embodiment, an explanation is provided with respect to an example of calculating a magnification factor of a thumbnail based on the size of a crop region. Since the configuration of the controller according to the present embodiment is the same as the above-described First Embodiment, the explanation thereof is omitted. Hereinafter, an explanation is provided with respect to points differing from the First Embodiment.

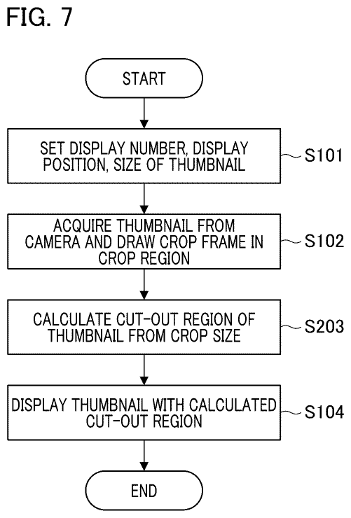

FIG. 7 is a flowchart showing an example of thumbnail display processing for displaying thumbnails that include a crop frame in the Second Embodiment. Since only step S203 is processing differing from the First Embodiment, hereinafter, an explanation is provided with respect to only step S203.

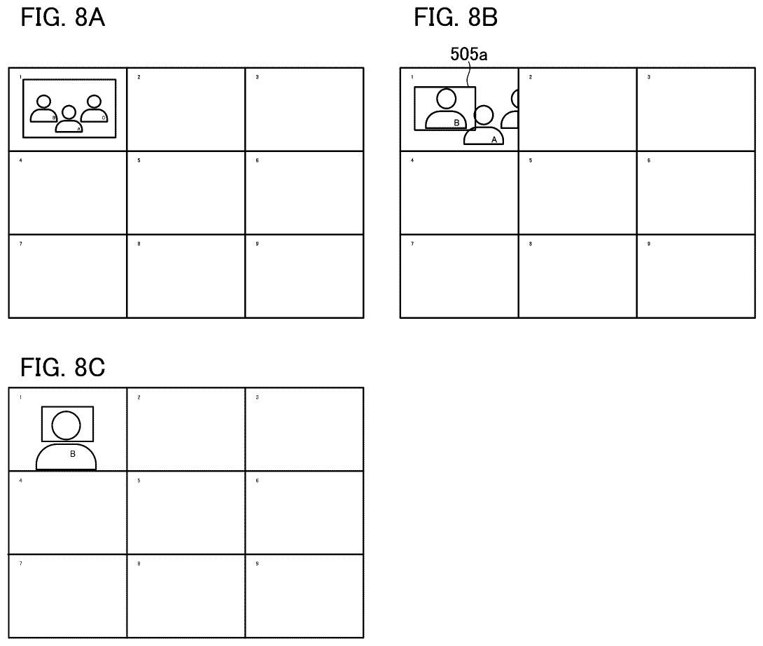

In step S203, the control unit 105 calculates a magnification factor of a cut-out region from a size of a crop region (crop frame 505a) (hereinafter referred to as a “crop size”). FIG. 8A to FIG. 8C are diagrams showing a thumbnail display in a case in which the crop size differs. FIG. 8A shows a case in which the crop size is “large”, and the magnification factor of the cut-out region is set to 100%. FIG. 8B shows a case in which the crop size is “medium”, and the magnification factor of the cut-out region is set to 200% so as to be larger than the magnification factor for the large size. FIG. 8C shows a case in which the crop size is “small”, and the magnification factor of the cut-out region is set to 500% so as to be larger than the magnification factor for the medium size.

As described above, according to the present embodiment, the controller 100 acquires a preset thumbnail and a crop region from the camera 10 having a crop function, and sets the magnification factor of the cut-out region to be larger as the crop size becomes smaller. In this manner, in a case in which the crop size is “large” or “medium”, the user can see not only the crop region but also outside the crop region in the preset thumbnail, and the composition after cropping becomes easier to see. In contrast, in a case in which the crop size is relatively small, for example, smaller than “medium”, the user can confirm the crop region displayed by being enlarged. That is, visibility can be improved when the user confirms the thumbnail image including the crop region.

### Third Embodiment

In a third embodiment, an explanation is provided with respect to an example of calculating a cut-out region according to the display size of the thumbnail and size of the crop region by combining the above-described first embodiment and second embodiment. In the present embodiment, as the display size of the thumbnail becomes smaller, and also, as the crop region becomes smaller, the size of the cut-out region is set so as to become smaller, that is, the magnification factor of the cut-out region is set so as to become larger.

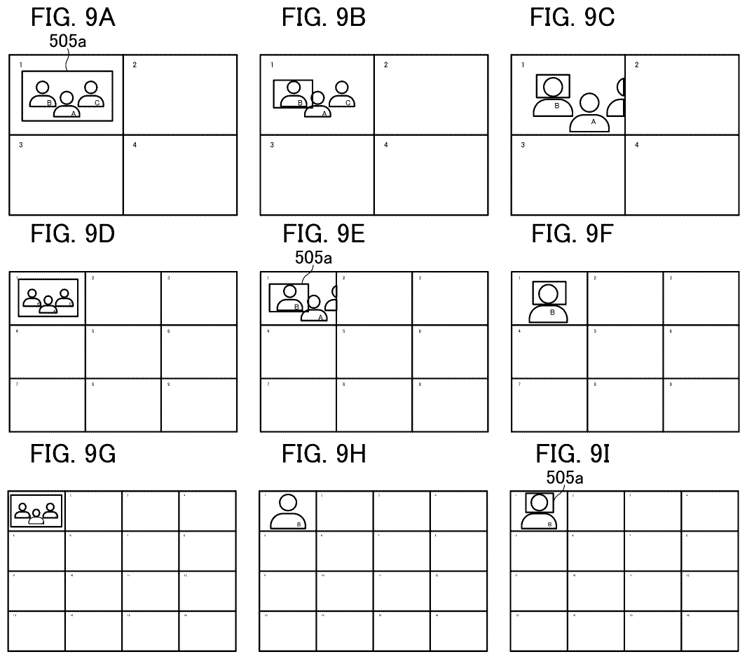

FIG. 9A to FIG. 9I are diagrams each showing an example of thumbnail display processing including the crop frame 505a in the third embodiment. In the present embodiment, in order to prevent the resolution of the thumbnail from becoming excessively small and becoming difficult to see, an upper limit of the magnification factor is set to, for example, 500%.

FIG. 9A to FIG. 9C are diagrams showing display examples in a case in which the display size of the thumbnail is “large”. In FIG. 9A, the crop size is “large”, and the magnification factor is set to, for example, 100%. In FIG. 9B, the crop size is “medium”, and the magnification factor is set to, for example, 110% so as to be a value no smaller than the magnification factor in FIG. 9A. In FIG. 9C, the crop size is “small”, and the magnification factor is set to, for example, 200% so as to be a value no smaller than the magnification factor in FIG. 9B.

FIG. 9D to FIG. 9F are diagrams showing display examples in a case in which the display size of the thumbnail is “medium”. In FIG. 9D, the crop size is “large”, and the magnification factor is set to, for example, 105% so as to be a value no smaller than the magnification factor in FIG. 9A. In FIG. 9E, the crop size is “medium”, and the magnification factor is set to, for example, 200% so as to be a value no smaller than the magnification factors in FIG. 9B and FIG. 9D. In FIG. 9F, the crop size is “small”, and the magnification factor is set to, for example, 480% so as to be a value no smaller than the magnification factors in FIG. 9C and FIG. 9E.

FIG. 9G to FIG. 9I are diagrams showing display examples in a case in which the display size of the thumbnail is “small”. In FIG. 9G, the crop size is “large”, and the magnification factor is set to, for example, 110% so as to be a value no smaller than the magnification factor in FIG. 9D. In FIG. 9H, the crop size is “medium”, and the magnification factor is set to, for example, 500% so as to be a value no smaller than the magnification factors in FIG. 9E and FIG. 9G. In FIG. 9I, the crop size is “small”, and the magnification factor is set to 500% so as to be a value no smaller than the magnification factors in FIG. 9F and FIG. 9H, in this case, for example, so as to satisfy the upper limit of the magnification factor.

As described above, according to the present embodiment, as the display size of the thumbnail and the size of the crop region become smaller, the magnification factor of the cut-out region is set to be larger. In this manner, according to the display size of the thumbnail and the size of the crop region, inside and outside of the crop region are made easier to see, and composition after cropping can be appropriately expressed.

### Fourth Embodiment

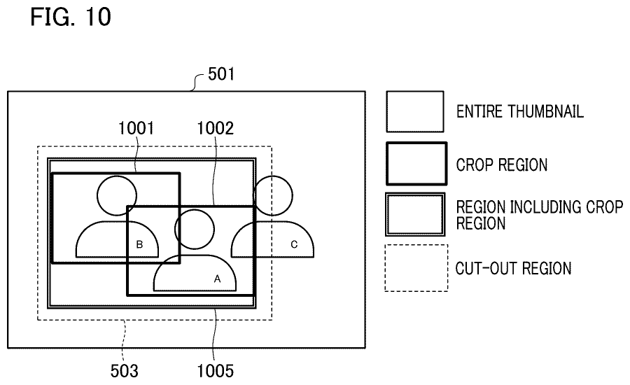

Although in the above-described First to Third Embodiments, a crop region (crop frame) included in a preset thumbnail was one, in the Fourth Embodiment, a plurality of crop regions are included in a preset thumbnail. FIG. 10 is a diagram showing an example of calculation of the cut-out region 503 of a thumbnail having two crop regions 1001 and 1002 in the Fourth Embodiment.

The cut-out region 503 (or a encompassment region 1005) is a rectangular region that includes the crop regions 1001 and 1002, and is set to have the same aspect ratio as the crop regions 1001 and 1002. The control unit 105 of the present embodiment calculates the cut-out region 503 based on the size of the encompassment region 1005 of the crop regions 1001 and 1002 instead of the size of the crop region in the Second Embodiment. As the size of the encompassment region 1005 of the crop regions becomes smaller, the size of the cut-out region 503 is set so as to become smaller, that is, the magnification factor of the cut-out region 503 is set so as to become larger.

It should be noted that in a case in which the aspect ratio of the crop region is not a fixed value, in a case in which aspect ratios of two or more crop regions differ, the size of the cut-out region may be set to an aspect ratio determined by a predetermined calculation formula based on the aspect ratios of the crop regions. The predetermined calculation formula is, for example, a formula for obtaining an average value or a median value of two or more aspect ratios.

### Fifth Embodiment

In a Fifth Embodiment, the control unit 105 changes a display form of a thumbnail in a case in which the thumbnail is displayed by being cut out with a cut-out region, with respect to a form in which the entire image of the thumbnail is displayed without modification (in a case in which the magnification factor of the cut-out region is 100%). A case in which the thumbnail is displayed by being cut out means a case in which the magnification factor of the cut-out region exceeds 100%. In this manner, it is possible to explicitly indicate that the thumbnail is displayed by being cut out.

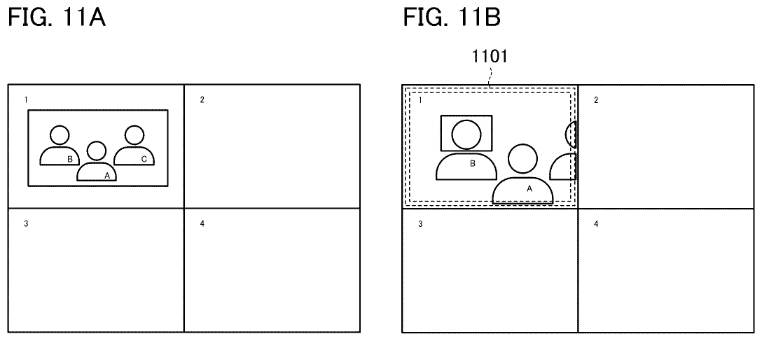

FIG. 11A shows an example in which the entire thumbnail acquired by the control unit 105 is displayed without modification. In contrast, as shown in FIG. 11B, in a case in which the control unit 105 cuts out the thumbnail with the cut-out region, by displaying an image such as a dashed line 1101 superimposed along an outline of the thumbnail, the control unit 105 can cause the user to recognize that the thumbnail has been cut out. In the present embodiment, an image indicating that the thumbnail has been cut out within the cut-out region is not limited to a dashed line, and examples of the image include a thick line, a line having a color, a blinking image, or a combination of these.

### Sixth Embodiment

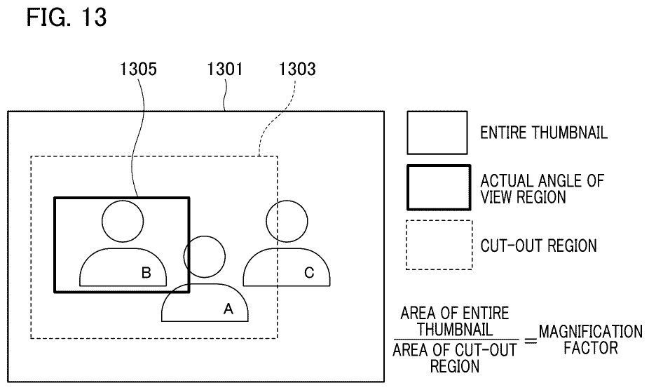

In a Sixth Embodiment, an explanation is provided with respect to an example of performing thumbnail display by using an image captured at a wide angle by the camera 10. Hereinafter, an explanation is provided with respect to points differing from the First Embodiment. Points in which the Sixth Embodiment differs from the First Embodiment are that, in the Sixth Embodiment, mainly, the camera 10 of the present embodiment has a function for performing image capturing of the image capturing angle of view at a wide angle, and also, that the camera 10 does not have a crop function. The controller 100 of the present embodiment performs processing of display of a thumbnail by utilizing an image captured by execution of a preset (an image of an actual angle of view region) and an image obtained by wide-angle image capturing (an overhead image). Methods for controlling the image capturing angle of view to a wide angle include, in addition to using a wide-angle lens, performing image capturing by changing a zoom position to a side wider than the actual angle of view region, and the like. An actual angle of view region 1305 will be explained below by using FIG. 13.

In addition, the angle of view of the overhead image need not necessarily be a wide angle. However, in the explanation below, an explanation is provided with respect to the overhead image as an image captured at a wide angle.

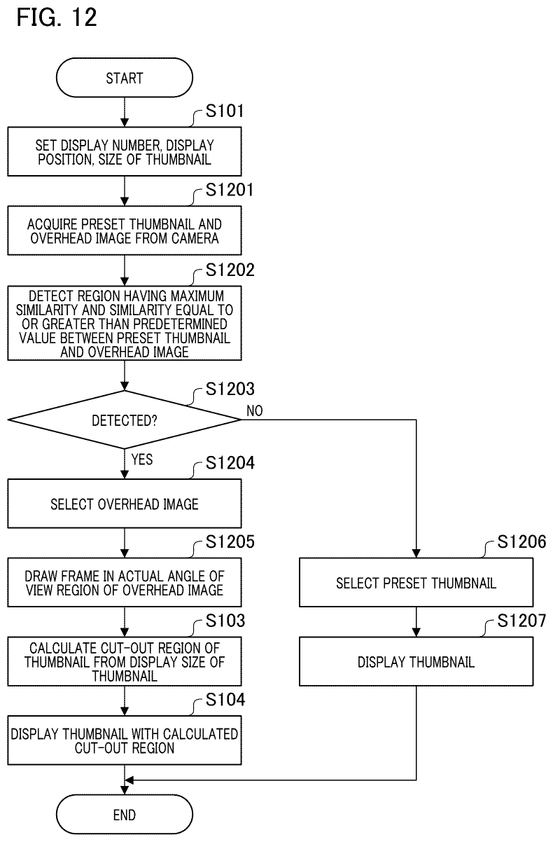

FIG. 12 is a flowchart showing an example of thumbnail display processing in the present embodiment. This processing is realized by the processor of the control unit 105 loading into the volatile memory by reading out a program corresponding to processing content stored in the non-volatile memory 102, and executing the program. Hereinafter, an explanation is provided with respect to thumbnail display processing in the control unit 105 and the display unit 103 by using the flowchart of FIG. 12. In the explanation of thumbnail display processing shown in FIG. 12 and thereafter, an example is explained in which information indicating an actual angle of view region is displayed by being superimposed on the generated thumbnail.

The processing of step S101 is the same as that in the First Embodiment (FIG. 4). In step S1201, the control unit 105 acquires a preset thumbnail and an overhead image from the camera 10. The preset thumbnail and the overhead image are captured at the time of registration of the preset, and are stored by the camera 10. The overhead image may be captured not only at the time of registration of the preset, but also at the time of installation of the camera 10, and may be stored by the camera 10.

The preset thumbnail is, as described above, a thumbnail corresponding to an image captured after executing a preset by the camera 10, that is, an image of the actual angle of view region. In contrast, the overhead image is an image captured by changing the zoom position to the wide-angle side. In a normal case, since the preset thumbnail and the overhead image are captured at the time of registration of the preset, the angle of view region of the preset thumbnail is included in the angle of view region of the overhead image. However, cases in which the angle of view region of the preset thumbnail is not included in the angle of view region of the overhead image can also be expected. For example, even if the preset thumbnail is generated, the preset thumbnail may be generated by being preset at a position outside the angle of view region of the overhead image. In this case, the angle of view of the overhead image does not include the entire angle of view of the preset thumbnail. Here, the angle of view region including another angle of view region means including the entire other angle of view region, and does not mean including only a part of the other angle of view region.

It should be noted that in step S1201, the control unit 105 may acquire an overhead image having a reduced size (for example, a thumbnailed overhead image) at the camera 10 side.

In steps S1202 and S1203, the control unit 105 performs detection processing of whether or not the angle of view region of the preset thumbnail, that is, the actual angle of view region, exists in the angle of view region of the overhead image. Specifically, first in step S1202, the control unit 105 detects a region having a maximum similarity and a similarity equal to or greater than a predetermined value between the preset thumbnail and the overhead image. Detection of the region having the maximum similarity and the similarity equal to or greater than the predetermined value means that the angle of view region of the overhead image includes the angle of view region of the preset thumbnail (the entire angle of view region). Hereinafter, for convenience of explanation, the detected region having the maximum similarity and the similarity equal to or greater than the predetermined value is referred to as a “target region”. The control unit 105 is an example of a detection unit that detects the second angle of view region from the first image by cooperating with a predetermined program.

The similarity can be calculated, for example, as follows. After converting the preset thumbnail and the overhead image, candidates for the detection processing, into low-resolution images of 8 pixels vertically and 8 pixels horizontally, differences in gradation values are calculated for 64 pixels of each image after conversion. Then, a reciprocal of a sum of the differences is calculated, and the reciprocal is set as the similarity.

In step S1203, in a case in which the control unit 105 has detected the target region, in step S1204, the control unit 105 selects the overhead image as an image to be used for thumbnail display.

In step S1205, the control unit 105 draws a frame surrounding the target region detected in step S1202 in the selected overhead image. This frame is a frame surrounding the actual angle of view region, and is an example of information indicating the second angle of view region. Hereinafter, this frame is referred to as an “actual angle of view frame”.

In step S103, the control unit 105 calculates a cut-out region of a thumbnail from the overhead image based on the display size set in step S101. In the present embodiment, calculation of the cut-out region mainly means calculation of a magnification factor of the cut-out region (a magnification factor of the overhead image displayed as a thumbnail).

As the display size of the thumbnail becomes smaller, the thumbnail becomes more difficult to see for the user. Accordingly, in order to display an appropriately sized thumbnail according to the display size of the thumbnail list, the control unit 105 executes processing of performing an appropriate size cut-out from the overhead image, and enlarging the cut-out region. The control unit 105 generates a thumbnail by cutting out a region including the actual angle of view region. Hereinafter, an explanation is provided with respect to the generation of a thumbnail by cutting out a region including the actual angle of view region.

FIG. 13 is an explanatory diagram showing a calculation method of a cut-out region 1303 of a thumbnail. Here, an explanation is provided with respect to a case in which the actual angle of view region is included in the angle of view region of the overhead image. The actual angle of view region is an example of a second angle of view region.

In FIG. 13, with respect to the entire thumbnail of the overhead image (an entire thumbnail 1301), the actual angle of view region 1305 is represented by a thick frame, and the cut-out region 1303 is represented by a dashed line. The cut-out region 1303 is a region that is displayed on the display unit 103 as a new thumbnail, and the region other than the cut-out region 1303 is not displayed. A magnification factor can be obtained using (area of the entire thumbnail 1301)/(area of the cut-out region 1303). In the present embodiment, similar to FIG. 5 explained in the First Embodiment, as the display size of the thumbnail becomes smaller, the size of the cut-out region is set so as to become smaller, that is, the magnification factor of the cut-out region is set so as to become larger. For example, in a case in which the display size of the thumbnail is “large” (960×540), the magnification factor is set to 100%, in a case in which the display size of the thumbnail is “medium” (640×360), the magnification factor is set to 200%, and in a case in which the display size of the thumbnail is “small” (480×270), the magnification factor is set to 500%.

The position (position of the thumbnail) of the cut-out region 1303 and an upper limit of the magnification factor are set in such a manner that the actual angle of view region 1305 is included within the cut-out region 1303. For example, the cut-out region is determined so that the center of the actual angle of view region 1305 is positioned at a position as close as possible to the center of the cut-out region. Alternatively, the cut-out region 1303 is determined so that the actual angle of view region 1305 is positioned at a position according to a predetermined algorithm other than the method of positioning the center of the actual angle of view region 1305 as close as possible to the center of the cut-out region.

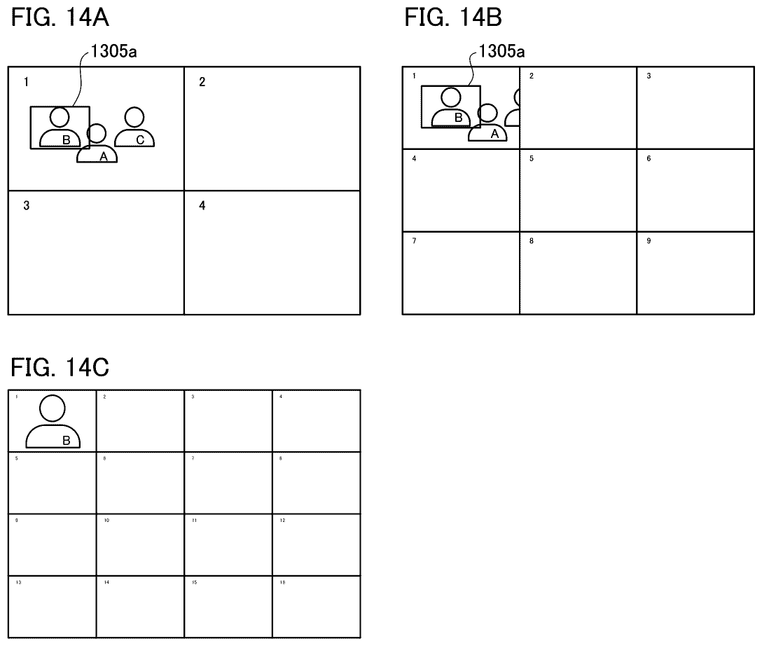

In step S104, the control unit 105 displays the cut-out region enlarged with the magnification factor calculated in step S103 as a thumbnail on the display unit 103. At this time, the control unit 105 also displays an actual angle of view frame 1305A indicating the actual angle of view region 1305 by superimposing the actual angle of view frame 1305A on the thumbnail. FIG. 14A to FIG. 14C are diagrams each showing a display example of a thumbnail including the actual angle of view frame 1305A.

In step S1203, in a case in which the control unit 105 did not detect the target region, in step S1206, the control unit 105 selects the preset thumbnail as an image to be used for thumbnail display.

In step S1207, the control unit 105 displays the preset thumbnail selected in step S1206 without modification as a thumbnail on the display unit 103.

In FIG. 14A, the display size of the thumbnail is “large”, and the magnification factor of the cut-out region is 100%, that is, substantially the entire original thumbnail 1301 is displayed as the thumbnail without any change.

In FIG. 14B, the display size of the thumbnail is “medium”, and the magnification factor of the cut-out region is set to, for example, 200%.

In FIG. 14C, the display size of the thumbnail is “small”, and the magnification factor of the cut-out region is set to, for example, 500%. In FIG. 14C, for example, only the actual angle of view region 1305 is displayed as the thumbnail by being cut out. Here, an example is shown in which the cut-out region 1303 and the actual angle of view region 1305 are identical. In a case in which the cut-out region and the actual angle of view region 1305 are identical in this manner, the actual angle of view frame 1305A may not be displayed. Alternatively, the actual angle of view frame may be displayed along the outline of the entire cut-out region. In addition, in FIG. 14C, since the actual angle of view frame is not displayed, the preset thumbnail may be displayed as the thumbnail instead of the overhead image.

An upper limit may be set for the magnification factor (a lower limit of the size of the cut-out region). The reason an upper limit is set for the magnification factor is the same as the reason described above in the First Embodiment.

In contrast, the lower limit of the magnification factor may be set to a value greater than 100%, and even in a case in which the display size of the thumbnail set by the user is “large”, the thumbnail may still be displayed in an enlarged state.

As described above, according to the present embodiment, the controller 100 acquires a preset thumbnail and an overhead image from the camera 10, detects the actual angle of view region, and sets the magnification factor of the cut-out region to be larger as the display size of the thumbnail becomes smaller. In this manner, in a case in which the display size of the thumbnail is “large” or “medium”, the user can see not only the actual angle of view region but also regions outside the actual angle of view region in the thumbnail display, and the composition becomes easier to see. In contrast, in a case in which the thumbnail is relatively small, for example, smaller than “medium”, the user can confirm the actual angle of view region displayed by being enlarged. That is, visibility can be improved when the user confirms the thumbnail display including the actual angle of view region.

### Seventh Embodiment

In a Seventh Embodiment, an explanation is provided with respect to an example of generating a thumbnail display by using an image captured at a wide angle by one or more cameras different from the camera 10. Hereinafter, an explanation is provided with respect to points differing from the Sixth Embodiment.

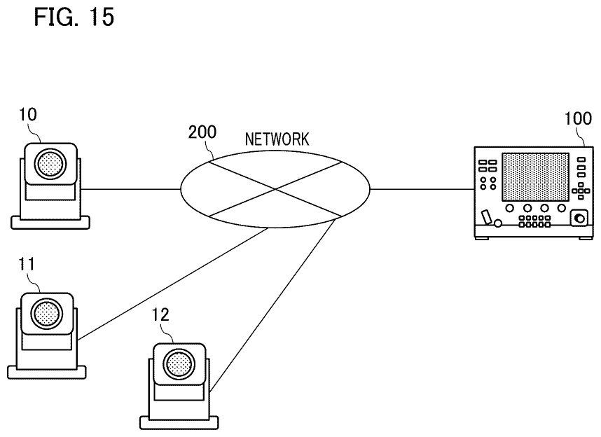

FIG. 15 is a diagram showing a configuration example of a control system in the present embodiment. The control system in the present embodiment includes a controller 100, a camera 10, an overhead camera 11, and an overhead camera 12. The controller 100, the camera 10, the overhead camera 11, and the overhead camera 12 are connected via the network 200.

The overhead camera 11 and the overhead camera 12 have a configuration similar to the camera 10, and further have a function for performing image capturing at a wide angle. It should be noted that it is irrelevant whether or not the camera 10 has a function for performing image capturing at a wide angle.

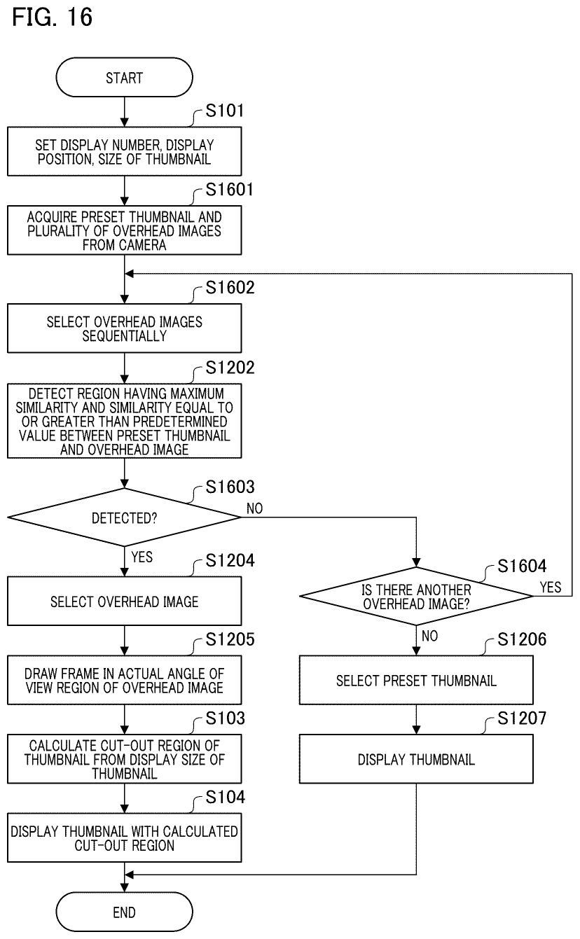

FIG. 16 is a flowchart showing an example of thumbnail display processing in the present embodiment. In this processing, since the processing of steps S101, S1202, S1204 to S1207, S103, and S104 is the same as the processing of FIG. 12, the explanation thereof is omitted.

After step S101, in step S1601, the control unit 105 acquires a preset thumbnail from the camera 10. The control unit 105 acquires one overhead image each from the overhead camera 11 and the overhead camera 12. Although the present embodiment can be implemented by using three or more overhead cameras, in that case, in step S1601, the control unit 105 acquires one overhead image from each of all overhead cameras.

In step S1602, the control unit 105 selects overhead images sequentially. Here, first, the control unit 105 selects one overhead image acquired from one overhead camera. Since the control unit 105 uses the overhead camera 11 and the overhead camera 12, when executing step S1602 for the first time, the control unit 105 selects an overhead image acquired from the overhead camera 11. Then, when executing step S1602 for the second time (processing after the “Yes” determination of step S1604 described below), the control unit 105 selects an overhead image acquired from the overhead camera 12.

In step S1603, in a case in which the control unit 105 detects a target region, the processing proceeds to step S1204, and the control unit 105 selects one overhead image including the target region. In a case in which the control unit 105 does not detect a target region, the processing proceeds to step S1604.

In step S1604, in a case in which there is another overhead image, the processing returns to step S1602, and in a case in which there is no other overhead image, the control unit 105 proceeds to step S1206.

In step S104, as explained in the Sixth Embodiment, the display unit 103 performs thumbnail display in display forms shown in FIG. 14A to FIG. 14C, respectively. It should be noted that since a plurality of overhead images are acquired in the present embodiment, in step S104, in a case in which a plurality of overhead images are selected in step S1204, a plurality of thumbnails corresponding to the overhead images may be displayed. Alternatively, in step S104, one thumbnail finally selected from among the plurality of thumbnails by a predetermined method may be displayed.

As described above, according to the present embodiment, the controller 100 acquires a thumbnail image from the camera 10, acquires one overhead image from each of the overhead camera 11 and the overhead camera 12, and after having acquired these images, detects the actual angle of view region from these overhead images. Then, by setting the magnification factor of the cut-out region to be larger as the display size of the thumbnail becomes smaller, effects similar to the Sixth Embodiment described above can be obtained.

In addition, according to the present embodiment, even in a case in which a plurality of overhead images are captured, the controller 100 can display a thumbnail including the actual angle of view frame 1305A by selecting one overhead image including the actual angle of view region.

### Eighth Embodiment

In an Eighth Embodiment, an explanation is provided with respect to an example of applying the control system of the present disclosure to CG (Computer Graphics). In CG, a virtual subject, a virtual light source, and a virtual camera are defined, and the computer generates, by calculation, the virtual subject illuminated by the virtual light source as an image observed from a viewpoint of the virtual camera. The computer generates at least one of a preset thumbnail and an overhead image by changing the angle of view of the virtual camera. The controller acquires the preset thumbnail and the overhead image, and displays the actual angle of view region and a region outside of the actual angle of view region as a thumbnail, similar to the Sixth Embodiment.

As the configuration of the control system in the present embodiment, for example, the computer and the controller may be connected via the network 200 (FIG. 1), or the computer and the controller may be connected not via the network 200. This Eighth Embodiment is also applicable to the First to Fifth Embodiments described above that relate to the crop function.

### Ninth Embodiment

In a Ninth Embodiment, an explanation is provided with respect to an example of performing display processing by using an overhead image captured at a wide angle by the camera 10. Since the Ninth Embodiment combines the essence of the Second Embodiment with the Sixth Embodiment, an explanation is provided with respect to points differing from the Second and Sixth Embodiments. In the present embodiment, similar to how the magnification factor of the thumbnail was calculated based on the size of the crop region in the Second Embodiment, in the present embodiment, the magnification factor of the thumbnail, that is, the cut-out region from the overhead image, is calculated based on the size of the actual angle of view region.

In the present embodiment, in a case in which the size of the actual angle of view region is “large”, the magnification factor of the cut-out region of the thumbnail from the overhead image is set to 100%. In a case in which the size of the actual angle of view region is “medium”, the magnification factor of the cut-out region is set to 200% so as to be greater than the magnification factor in a case in which the size of the actual angle of view region is “large”. In a case in which the size of the actual angle of view region is “small”, the magnification factor of the cut-out region is set to 500% so as to be greater than the magnification factor in a case in which the size of the actual angle of view region is “medium”.

As described above, according to the present embodiment, the controller 100 first acquires a thumbnail image and an overhead image from the camera 10, and then detects the actual angle of view region, and sets the magnification factor of the cut-out region to be larger as the size of the actual angle of view region becomes smaller. In this manner, in a case in which the size of the actual angle of view region is “large” or “medium”, the user can see not only the actual angle of view region but also a region outside of the actual angle of view region in the thumbnail display, and the composition becomes easier to see. In contrast, in a case in which the size of the actual angle of view region is relatively small, for example, smaller than “medium”, the user can confirm the actual angle of view region displayed by being enlarged. That is, visibility can be improved when the user confirms the thumbnail display including the actual angle of view region.

In the present embodiment, as described in the Seventh Embodiment, the magnification factor of the thumbnail may be calculated based on the size of the actual angle of view region by using an overhead image captured at a wide angle by one or more cameras different from the camera 10.

Alternatively, as described in the Eighth Embodiment, the magnification factor of the thumbnail may be calculated based on the size of the actual angle of view region by using an overhead image captured at a wide angle by a virtual camera in computer graphics.

### Tenth Embodiment

In the Tenth Embodiment, an explanation is provided with respect to an example of performing thumbnail display processing by using an overhead image captured at a wide angle by the camera 10. Since the present embodiment performs processing basically similar to the Sixth Embodiment, an explanation is provided with respect to points differing from the Sixth Embodiment. Similar to how the cut-out region was calculated according to the display size of the thumbnail and the size of the crop region in the Third Embodiment, in the present embodiment, the cut-out region is calculated according to the display size of the thumbnail and the size of the actual angle of view region.

In the present embodiment, as the display size of the thumbnail becomes smaller, and also, as the actual angle of view region becomes smaller, the size of the cut-out region is set so as to become smaller, that is, the magnification factor of the cut-out region is set so as to become larger. In this manner, according to the display size of the thumbnail and the size of the actual angle of view region, inside and outside of the crop region are made easier to see, and composition can be appropriately expressed.

In the present embodiment, as described in the Seventh Embodiment, an overhead image captured at a wide angle by one or more cameras different from the camera 10 is used, and the magnification factor of the thumbnail may be calculated based on the display size of the thumbnail and the size of the actual angle of view region.

Alternatively, as described in the Eighth Embodiment, an overhead image captured at a wide angle by a virtual camera in computer graphics is used, and the magnification factor of the thumbnail may be calculated based on the display size of the thumbnail and the size of the actual angle of view region.

### Eleventh Embodiment

In the Eleventh Embodiment, an explanation is provided with respect to an example of performing thumbnail display processing by using an overhead image captured at a wide angle by the camera 10. Since the present embodiment performs processing basically similar to the Sixth Embodiment, an explanation is provided with respect to points differing from the Sixth Embodiment. The present embodiment controls the display size of the thumbnail according to the size of the actual angle of view region with respect to the thumbnail. The display size of the thumbnail in the First to Tenth Embodiments was predetermined according to the number of thumbnails (the number of rows and columns in a matrix), as shown in, for example, FIG. 3A to FIG. 3C, such as “2×2”, “3×3”, “4×4”. In contrast, the present embodiment differs from the First to Ninth Embodiments in that the display size of the thumbnail is determined according to the size of the actual angle of view region.

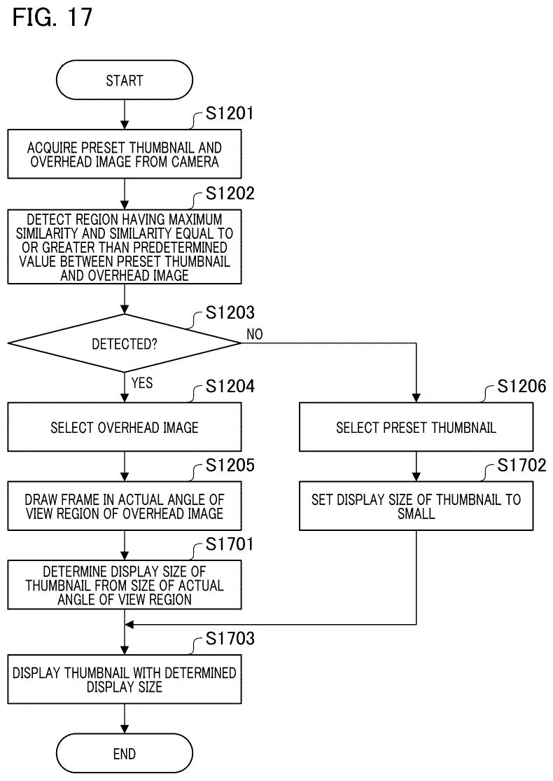

FIG. 17 is a flowchart showing an example of thumbnail display processing in the present embodiment. In this processing, since the processing of steps S1201 to S1206 is the same as FIG. 12, the explanation thereof is omitted.

After step S1205, in step S1701, the control unit 105 determines the display size of the thumbnail based on the size of the actual angle of view region. As the display size of the actual angle of view region within the thumbnail becomes smaller, the actual angle of view region becomes more difficult to see for the user. In a case in which a size ratio of the actual angle of view region to the size of the overhead image is equal to or less than a predetermined value, the control unit 105 determines the display size of the thumbnail to be “large”, and in a case in which the size ratio is not equal to or less than the predetermined value, the control unit 105 determines the display size of the thumbnail to be “small”. The predetermined value is, for example, ½, although the predetermined value is not limited thereto. In addition, the display size of the thumbnail may be determined from three options of “large”, “medium”, and “small”, or may be determined from four or more display sizes of the thumbnail.

After step S1206, in step S1702, the control unit 105 determines the display size of the thumbnail to be “small”. Because the actual angle of view region does not exist in the overhead image, making the display size of the thumbnail small has little impact on the user.

In step S1703, the control unit 105 displays the thumbnail according to the display size of the thumbnail that was determined.

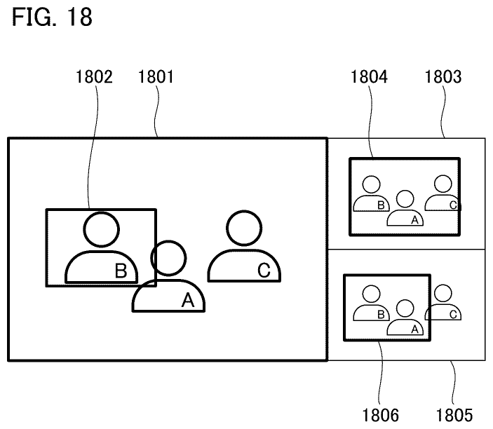

FIG. 18 is a diagram showing display examples of thumbnails, each including an actual angle of view frame. In thumbnail 1801, because a size ratio of the actual angle of view frame 1802 to the overhead image is equal to or less than a predetermined value, the display size of the thumbnail is “large”.

In thumbnail 1803, because a size ratio of the actual angle of view frame 1804 to the overhead image exceeds the predetermined value, the display size of the thumbnail is “small”.

In thumbnail 1805, because a size ratio of the actual angle of view frame 1806 to the overhead image exceeds the predetermined value, the display size of the thumbnail is “small”.

As described above, according to the present embodiment, the controller 100 detects the actual angle of view region after acquiring a preset thumbnail and an overhead image from the camera 10, and as the size ratio of the actual angle of view region to the overhead image becomes smaller, the controller 100 sets the display size of the thumbnail to be larger. In this manner, in a case in which the size of the actual angle of view region with respect to the thumbnail is small, visibility of the outside of the actual angle of view region can be improved. That is, visibility can be improved when the user confirms the thumbnail display including the actual angle of view region.

In the present embodiment, as described in the Seventh Embodiment, an overhead image captured at a wide angle by one or more cameras different from the camera 10 is used, and the display size of the thumbnail may be controlled according to the size of the actual angle of view region with respect to the thumbnail.

Alternatively, as described in the Eighth Embodiment, an overhead image captured at a wide angle by a virtual camera in CG is used, and the display size of the thumbnail may be controlled according to the size of the actual angle of view region with respect to the thumbnail.

### Twelfth Embodiment

In a Twelfth Embodiment, an explanation is provided with respect to an example of performing thumbnail display processing by using an overhead image captured at a wide angle by the camera 10. Since the Twelfth Embodiment combines the essence of the Fourth Embodiment with the Sixth Embodiment, an explanation is provided with respect to points differing from the Fourth and Sixth Embodiments. Similar to how a plurality of crop regions are included in a preset thumbnail in the Fourth Embodiment, in the present embodiment, a plurality of actual angle of view regions are included in a preset thumbnail. Because the actual angle of view region corresponds to composition when executing a preset by the camera 10, by operation of selecting one from the plurality of actual angle of view regions, operation of executing one preset from the preset thumbnail becomes possible.

The control unit 105 of the present embodiment detects two actual angle of view regions after acquiring an overhead image and two thumbnail images from the camera 10. The control unit 105 calculates the cut-out region based on a size of a region including the two actual angle of view regions instead of the size of the actual angle of view region in the Ninth Embodiment. That is, as the size of the region including the two actual angle of view regions becomes smaller, the size of the cut-out region is set so as to become smaller, that is, the magnification factor of the cut-out region is set so as to become larger.

In the present embodiment, as described in the Seventh Embodiment, an overhead image captured at a wide angle by one or more cameras different from the camera 10 is used, and the magnification factor of the thumbnail may be calculated based on the size of the region including the two actual angle of view regions.

Alternatively, as described in the Eighth Embodiment, an overhead image captured at a wide angle by a virtual camera in computer graphics is used, and the magnification factor of the thumbnail may be calculated based on the size of the region including the two actual angle of view regions.

### Thirteenth Embodiment

In a Thirteenth Embodiment, an explanation is provided with respect to an example of performing thumbnail display processing by using an overhead image captured at a wide angle by the camera 10. Since the Thirteenth Embodiment combines the essence of the Fifth Embodiment with the Sixth Embodiment, an explanation is provided with respect to points differing from the Fifth and Sixth Embodiments. In the present embodiment, similar to the Fifth Embodiment that changes the display form of the thumbnail in a case in which the entire image of the thumbnail is displayed without modification, the display form of the thumbnail is changed in a case in which the thumbnail is displayed by being cut out with a cut-out region from the overhead image.

In a case in which the control unit 105 cuts out the thumbnail by the cut-out region from the overhead image, by displaying an image such as a dashed line superimposed along an outline of the thumbnail, the control unit 105 can cause the user to recognize that the thumbnail has been cut out.

In the present embodiment, as described in the Seventh Embodiment, an overhead image captured at a wide angle by one or more cameras different from the camera 10 is used, and the display form of the thumbnail may be changed in a case in which the thumbnail is displayed by being cut out by the cut-out region.

Alternatively, as described in the Eighth Embodiment, an overhead image captured at a wide angle by a virtual camera in computer graphics is used, and the display form of the thumbnail may be changed in a case in which the thumbnail is displayed by being cut out by the cut-out region.

### OTHER EMBODIMENTS

Although the controller 100 according to the above-described embodiments displayed information indicating a crop region (for example, a crop frame) in the thumbnail image, the controller 100 may not display the information. Alternatively, the controller 100 may enable a user to selectively operate display and non-display of the information indicating the crop region.

In the present disclosure, as a processor or a circuit that configures at least a part of the control unit 105, not limited to a CPU, an ASIC may be used, or a PLD (Programmable Logic Device) such as an FPGA (Field Programmable Gate Array) may be used. Alternatively, a DSP (Digital Signal Processor) may be used.

The Eleventh Embodiment described above determined the display size of the thumbnail according to the size of the actual angle of view region. Here, “actual angle of view region” may be replaced with a crop region. That is, with similar intent to the Eleventh Embodiment, the display size of the thumbnail may be determined according to the size of the crop region.

At least two embodiments of the above-described First to Thirteenth Embodiments may be combined.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-122942, filed Jul. 30, 2024, and Japanese Patent Application No. 2025-20828, filed Feb. 12, 2025 which are hereby incorporated by reference wherein in their entirety.

What is claimed is:

1. A display control apparatus comprising:
one or more memories storing instructions; and
one or more processors executing the stored instructions to:
acquire at least a first image among one or more images acquired by one or more image capturing apparatuses;
determine, based on at least one of a size of a display region of a thumbnail image on a display screen and a size of a second angle of view region that is smaller than a first angle of view region that is a region of an angle of view of the first image, a cut-out region from the first image including the second angle of view region; and
perform display processing to display an image which is cut out from the first image and which corresponds to the determined cut-out region.

2. The display control apparatus according to claim 1, wherein the cut-out region is determined by calculating a magnification factor of the thumbnail image based on at least one of the size of the display region of the thumbnail image and the size of the second angle of view region.

3. The display control apparatus according to claim 1, wherein
the one or more processors further execute the stored instructions to set the size of the cut-out region, and
the smaller the size of the display region of the thumbnail image, the smaller the size of the cut-out is set.

4. The display control apparatus according to claim 1, wherein
the one or more processors further execute the stored instructions to set the size of the cut-out region, and
the smaller the size of the second angle of view region, the smaller the size of the cut-out is set.

5. The display control apparatus according to claim 1, wherein the one or more processors further execute the stored instructions to set at least one of an upper limit and a lower limit of the size of the cut-out region.

6. The display control apparatus according to claim 1, wherein the display processing includes processing to display an image indicating that the first image has been cut out within the cut-out region, superimposed on the thumbnail image.

7. The display control apparatus according to claim 1, wherein at least one of the first image and a second image that is an image of the second angle of view region is an image generated by computer graphics.

8. The display control apparatus according to claim 1, wherein in a case in which the image capturing apparatus has a function to output an image of a crop region that is a part of a captured image cut out, the first image is a preset thumbnail image generated by being captured by the image capturing apparatus based on an angle of view registered in the image capturing apparatus, and the second angle of view region is a crop region that is a part of the preset thumbnail image that has been cut out.

9. The display control apparatus according to claim 8, wherein the one or more processors further execute the stored instructions:
acquire information related to the crop region from the image capturing apparatus; and
generate information indicating the crop region based on the information related to the crop region and superimpose the information indicating the crop region on the thumbnail image.

10. The display control apparatus according to claim 8, wherein in a case in which the image capturing apparatus has a function to output images of a plurality of crop regions, the one or more processors further execute the stored instructions to determine a cut-out region including the plurality of crop regions.

11. The display control apparatus according to claim 10, wherein
the one or more processors further execute the stored instructions to set a size of the cut-out region, and
the smaller a size of an encompassment region that encompasses the plurality of crop regions, the smaller the size of the cut-out region is set.

12. The display control apparatus according to claim 1, wherein the one or more processors further execute the stored instructions to detect the second angle of view region from the first image, and
wherein the cut-out region is determined based on at least one of the size of the display region of the thumbnail image on the display screen and the size of the detected second angle of view region.

13. The display control apparatus according to claim 12, wherein the first image is an image captured at a wide-angle by the image capturing apparatus.

14. The display control apparatus according to claim 12, wherein a second image that is an image of the second angle of view region is a preset thumbnail image generated by being captured by the image capturing apparatus based on an angle of view registered in the image capturing apparatus.

15. The display control apparatus according to claim 14, wherein the second angle of view region is detected by calculating a similarity between the first image and the preset thumbnail image.

16. The display control apparatus according to claim 12, wherein the display processing includes processing to generate information indicating the detected second angle of view region and superimposing the information on the thumbnail image.

17. The display control apparatus according to claim 12, wherein the one or more processors further execute the stored instructions to set the size of the display region of the thumbnail image larger as the size of the second angle of view region becomes smaller.

18. The display control apparatus according to claim 12, wherein execution of the stored instructions by the processor further causes the display control apparatus to determine a cut-out region including a plurality of second angle of view regions in a case in which the plurality of second angle of view regions are detected.

19. A method for a display control apparatus, the method comprising:
acquiring at least a first image among one or more images acquired by one or more image capturing apparatuses;
determining, based on at least one of a size of a display region of a thumbnail image on a display screen and a size of a second angle of view region that is smaller than a first angle of view region that is a region of an angle of view of the first image, a cut-out region from the first image including the second angle of view region; and
performing display processing to display an image which is cut out from the first image and which corresponds to the determined cut-out region.

20. A non-transitory storage medium storing a program of a display control apparatus causing a computer to perform each step of a method for the display control apparatus, the method comprising:
acquiring at least a first image among one or more images acquired by one or more image capturing apparatuses;
determining, based on at least one of a size of a display region of a thumbnail image on a display screen and a size of a second angle of view region that is smaller than a first angle of view region that is a region of an angle of view of the first image, a cut-out region from the first image including the second angle of view region; and
performing display processing to display an image which is cut out from the first image and which corresponds to the determined cut-out region.
